(19) United States
(12) Patent Application Publication
(10) Pub. No.: US 2014/0164217 A1
(43) Pub. Date: Jun. 12, 2014

(54) SYSTEMS AND METHODS FOR PROVIDING A DIGITAL BLANK CHECK

(71) Applicants: Luke A. Hammock, Washington, DC (US); Janusz Michael Niczyporuk, Vienna, VA (US); Drew Jacobs, Arlington, VA (US); Steven G. Chiagouris, Plano, TX (US)

(72) Inventors: Luke A. Hammock, Washington, DC (US); Janusz Michael Niczyporuk, Vienna, VA (US); Drew Jacobs, Arlington, VA (US); Steven G. Chiagouris, Plano, TX (US)

(73) Assignee: CAPITAL ONE FINANCIAL CORPORATION, McLean, VA (US)

(21) Appl. No.: 14/052,715

(22) Filed: Oct. 12, 2013

Related U.S. Application Data
(60) Provisional application No. 61/734,172, filed on Dec. 6, 2012.

(51) Int. Cl. G06Q 40/02

(52) U.S. Cl. CPC G06Q 40/025
USPC 705/38

(57) ABSTRACT

Systems and methods are provided for providing a digital blank check. The systems and methods may include a financial service provider providing loan terms to a customer. The financial service provider may receive, from a customer device, a first loan request relating to an item. The financial service provider may also generate a first offer based on the first loan request and provide the first offer to the customer device. The financial service provider may also receive, from the customer device at a point-of-sale location, a second loan request relating to the item. In response, the financial service provider may generate a second offer based on the second loan request and provide the second offer to the customer device at the point-of-sale location.

### PRIORITY CLAIM

This disclosure claims priority under 35 U.S.C. §119 to U.S. provisional patent application No. 61/734,172 filed on Dec. 6, 2012, and entitled “Systems and Methods for Providing a Digital Blank Check,” which is incorporated herein by reference in its entirety.

### TECHNICAL FIELD

The disclosed embodiments generally relate to a system and method for determining loan terms, and more particularly, to a system and method for determining loan terms based on customer information.

### BACKGROUND

Financial service providers, such as banks, credit card companies, merchants, lenders, and the like, typically offer loans to potential customers for purchasing expensive items, such as automobiles, in one of two ways. In the indirect model, potential customers may obtain a loan for an item through a merchant that sells the item. Alternatively, in the direct model, potential customers may obtain a loan directly through a financial service provider. To facilitate closing the transaction at the point-of-sale in the direct model, a potential customer may receive a paper blank check reflecting a loan offer from a financial service provider. The paper blank check provides loan terms offered by a financial service provider and allows a customer to use the paper blank check in accordance with the loan terms to make a purchase. Further, the paper blank check gives the seller confidence that a loan has indeed been offered and presents the seller with a familiar way to accept payment, i.e., accepting the paper check.

Customer supplied information, including information relating to loan criteria and customer loan optimization preferences, may affect the loan terms that are attached to the paper blank check or any loan offer. Information relating to loan criteria helps a financial service provider evaluate the risk of the loan and may include details about the customer or the item to be purchased. For example, information relating to loan criteria may include the automobile make, model, and year, the vehicle identification number (“VIN”), proof of income, proof of insurance, and back-end product information. Back-end product information includes features or additional items that may be purchased in connection with the item to be purchased. For example, back-end product information may include tire protection, paint rust proofing coat, extra warranty on the automobile, and gap insurance, which covers gaps between other insurance policies. A potential customer may also have loan optimization preferences, such as optimizing the interest rate, total monthly payment, or number of payments, or varying the down payment. If a financial service provider knows a customer's loan preferences, it may tailor the loan terms to the customer's preferences, making the offer more attractive to the customer.

Having as much up-to-date customer supplied information as possible enables financial service providers to offer competitive loans. As information might not be available at certain stages in the purchasing process, particularly when a customer first contemplates a loan, basing a loan offer on up-to-date information proves to be a challenge. For instance, prior to identifying an automobile for purchase, a customer may only know the make, model, and/or year of an automobile he or she is searching for. After identifying a specific automobile for purchase, the customer may learn the VIN, back-end product information, and/or the total purchase price of the vehicle. After negotiating with a merchant to purchase the automobile, the customer may obtain updated information and/or third party loan offers. Further, customers may change loan preferences or acquire new sources of income or insurance that may affect the terms of the loan offer.

While paper blank checks enable a potential customer to obtain a loan directly through a financial service provider, paper blank checks do not facilitate loan terms that reflect up-to-date information relating to loan criteria, particularly information acquired at a point-of-sale location. Thus, “direct” financial service providers may not be able to provide the most competitive loan offers to potential customers, decreasing the probability of a potential customer consummating a loan offer. Instead of consummating a loan offer, a potential customer may accept a more competitive offer from a third party based on up-to-date information, may decline to purchase an item because the loan terms are not agreeable, or may become confused in trying to compare various loan options from different service providers and restart the process. New solutions are needed to overcome these drawbacks.

### SUMMARY

Disclosed embodiments provide systems and methods that enable a financial service provider to determine loan terms for a customer using information provided by the customer at the point-of-sale location. The disclosed embodiments provide mechanisms that facilitate receipt of information from a customer at a point-of-sale location and provide an offer for a loan with terms corresponding to the provided information.

Consistent with disclosed embodiments, a system is provided for providing loan terms to a customer. In one aspect, the system may include a storage device storing instructions and a processor configured to execute the instructions in the storage device. The processor may execute the instructions to receive, from a customer device, a first loan request relating to an item. The processor may also execute the instructions to generate a first offer based on the first loan request and provide the first offer to the customer device. In addition, the processor may execute the instructions to receive, from the customer device at a point-of-sale location, a second loan request relating to the item. The processor may further execute the instructions to generate a second offer based on the second loan request and provide the second offer to the customer device at the point-of-sale location.

Consistent with disclosed embodiments, a method is provided for providing loan terms to a customer. In one aspect, the method may include receiving, from a customer device, a first loan request relating to an item. The method may also include generating a first offer based on the first loan request and providing the first offer to the customer device. The method may additionally include receiving, from the customer device at a point-of-sale location, a second loan request relating to the item. The method may further include generating a second offer based on the second loan request and providing the second offer to the customer device at the point-of-sale location.

Consistent with disclosed embodiments, a system is provided for providing loan terms to a customer. In one aspect, the system may include a storage device storing instructions and a processor configured to execute the instructions in the storage device. The processor may execute the instructions to receive, from a mobile device at a point-of-sale location, a loan request relating to an automobile. The processor may also execute the instructions to generate an offer based on the loan request and provide the offer to the customer device. The loan request may include one or more of a vehicle identification number, proof of income, proof of insurance, back-end product information, a customer loan optimization preference, and a third party offer. The offer may also include loan terms.

Consistent with other disclosed embodiments, tangible computer-readable storage media may store program instructions that are executable by one or more processors to implement any of the methods disclosed herein.

It is to be understood that both the foregoing general description and the following detailed description are exemplary and explanatory only, and are not restrictive of the disclosed embodiments.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a diagram of an exemplary system that may be used to provide a digital blank check.

FIG. 2 is a component diagram of an exemplary financial service provider terminal.

FIG. 3 is a flowchart of an exemplary method for determining loan terms for a customer.

FIG. 4 is a flowchart of an exemplary method for receiving a loan request.

FIG. 5 is a flowchart of an exemplary method for receiving information relating to loan criteria.

FIG. 6 is a flowchart of an exemplary process for generating an offer with loan terms.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

The disclosed embodiments are directed to systems and methods for determining loan terms based on customer supplied information in a loan request, which may include information relating to loan criteria, customer loan optimization preferences, and third party offers. The information in the loan request may enable the financial service provider to provide a more competitive loan offer because it better understands the risk of the loan.

In one embodiment, which is applicable to the direct model, a customer may request and receive a loan offer corresponding to information obtained at the point-of-sale location. For example, a potential customer may submit a loan request relating to an automobile be purchased to a financial service provider. Using information from the loan request, the financial service provider may evaluate the risk of the loan and provide the customer with an offer based on the loan request. The customer may accept the offer and use the loan to purchase the automobile. However, as is often the case, the customer may learn additional information at the point-of-sale location. Upon learning additional information, such as VIN, back-end products, and third party offers, the customer may submit an updated loan request to the financial service provider, for example, via a mobile phone while at the point-of-sale location. In response to the updated loan request, the financial service provider may generate an updated offer based on the updated loan request and provide it to the customer at the point-of-sale location. The customer may then use the updated offer to purchase the automobile without ever having left the point-of-sale location. The described method may be reiterated as additional information is obtained and provided to the financial service provider in additional loan requests, resulting in additional offers.

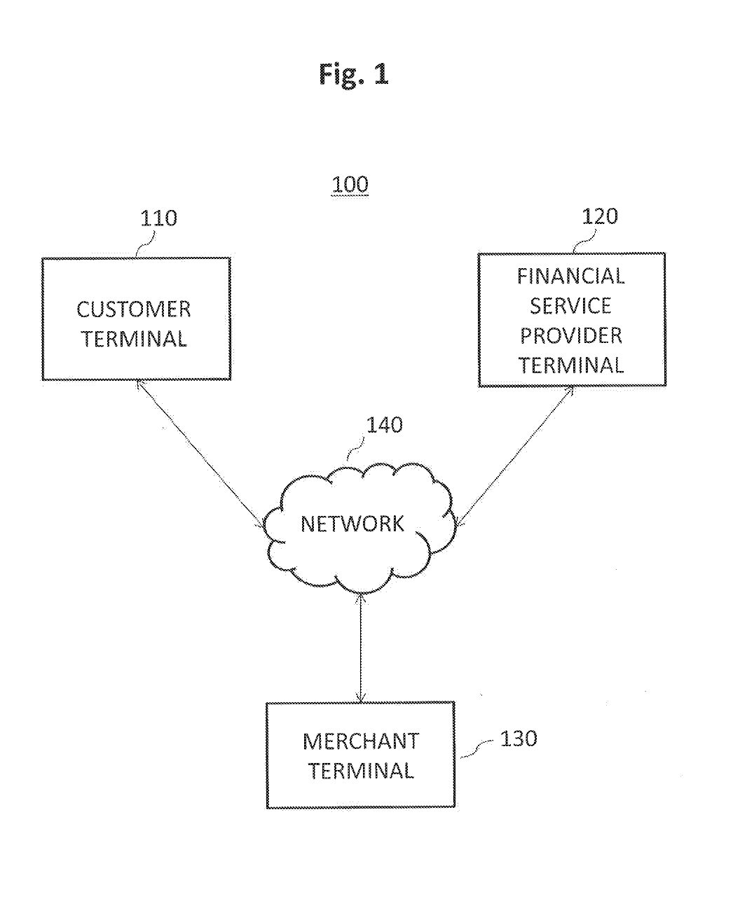

FIG. 1 shows a diagram of an exemplary system that is configured to perform one or more software processes that, when executed, provide a digital blank check that can be updated in view of updated loan criteria. The components and arrangements shown in FIG. 1 is not intended to limit the disclosed embodiments as the components used to implement the disclosed processes and features may vary.

In accordance with disclosed embodiments, a digital blank check system 100 may include a customer terminal 110, a financial service provider terminal 120, and a merchant terminal 130, each communicating with a network 140. Customer terminal 110 may be connected to financial service provider terminal 120 and merchant terminal 130 directly or via network 140. Financial service provider terminal 120 may be connected to merchant terminal 130 directly or via network 140. Other components known to one of ordinary skill in the art may be included in digital blank check system 100 to process, transmit, provide, and receive information consistent with the disclosed embodiments.

Customer terminal 110 may allow one or more potential customers to request a loan to purchase an item. For example, a customer may request an automobile loan to purchase an automobile at a point-of-sale location. The customer may be any type of customer, such as an online customer. Although the example of an automobile purchase is disclosed, the customer may purchase any kind of product. Further, the disclosed embodiments are applicable to existing customers of a financial service provider, and are not limited to new or potential customers.

Operating in communication with network 140, customer terminal 110 may be a computer-based system. For example, customer terminal 110 may include a general purpose or notebook computer, a mobile device with computing ability, a server, a desktop computer, tablet, or any combination of these computers and/or affiliated components. In one embodiment, customer terminal 110 may be a computer system or device that is operated by a user who is a customer or a potential customer of a financial service provider. In another embodiment, customer terminal 110 may be a mobile computer device that is operated by a potential customer of a financial service provider at a point-of-sale location. Customer terminal 110 may be configured with storage that stores one or more operating systems that perform known operating system functions when executed by one or more processors. By way of example, the operating systems may include Microsoft Windows™, Unix™, Linux™, Apple™ operating systems, Personal Digital Assistant (PDA) type operating systems, such as Microsoft CE™, or other types of operating systems. Accordingly, disclosed embodiments may operate and function with computer systems running any type of operating system. Customer terminal 110 may also include communication software that, when executed by a processor, provides communications with network 140, such as Web browser software, tablet, or smart hand held device networking software, etc. Customer terminal 110 may be a device that executes mobile applications, such as a tablet or mobile device.

Financial service provider terminal 120 may allow any number of financial service providers, such as banks, credit card companies, merchants, lenders, and the like, to offer and provide loans to potential customers. Although financial service providers may operate in the direct model, the financial service providers may be any type of financial service provider, such as a merchant selling an item to be purchased. Financial service provider terminal 120 may be a computer-based system including computer system components, such as one or more servers, desktop computers, workstations, tablets, hand held computing devices, memory devices, and/or internal network(s) connecting the components.

Merchant terminal 130 may allow any number of merchants to provide goods or services in exchange for payment via a particular payment system. Merchants using merchant terminal 130 may include traditional brick-and-mortar retail merchants, or any type of merchant, such as an online retail merchant. Each merchant may communicate directly or indirectly with financial service provider terminal 120 in order to finalize or verify the terms of an accepted loan offer. Merchant terminal 130 may be a computer-based system including computer system components, such as one or more servers, desktop computers, workstations, tablets, hand held computing devices, memory devices, and/or internal network(s) connecting the components.

Network 140 may comprise any type of computer networking arrangement used to exchange data. For example, network 140 may be the Internet, a private data network, or a virtual private network using a public network such as the Internet. Network 140 may also include a public switched telephone network (“PSTN”) and/or a wireless network.

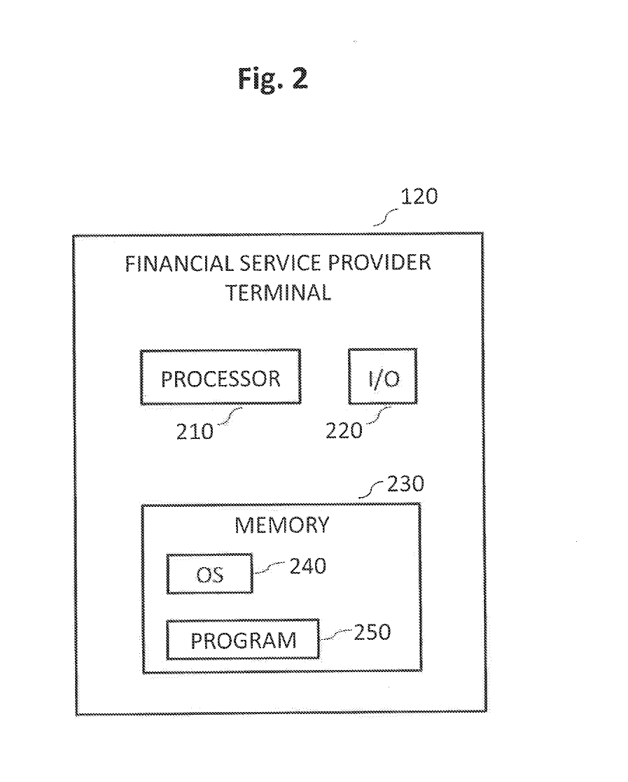

Financial service provider terminal 120 is shown in more detail in FIG. 2. Customer terminal 110 and merchant terminal 130 may have a similar structure and components that are similar to those described with respect to financial service provider terminal 120. As shown, financial service provider terminal 120 may include a processor 210, an input/output (“I/O”) device 220, a memory 230 containing an operating system (“OS”) 240 and a program 250. For example, financial service provider terminal 120 may be a single server or may be configured as a distributed computer system including multiple servers or computers that interoperate to perform one or more of the processes and functionalities associated with the disclosed embodiments.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. In another embodiment, processor 210 may include a multiple-core processor arrangement (e.g., dual or quad core) that is configured to provide parallel processing functionalities to allow server 200 to execute multiple processes simultaneously. One of ordinary skill in the art would understand that other types of processor arrangements could be implemented that provide for the capabilities disclosed herein.

Financial service provider terminal 120 may include one or more storage devices configured to store information used by processor 210 (or other components) to perform certain functions related to the disclosed embodiments. In one example, financial service provider 210 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, financial service provider terminal 120 includes memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, financial service provider terminal 120 may include memory 230 that may include one or more programs 250 to perform one or more functions of the disclosed embodiments. Moreover, processor 210 may execute one or more programs 250 located remotely from digital blank check system 100. For example, digital blank check system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft SQL databases, SharePoint databases, Oracle™ databases, Sybase™ databases, or other relational databases. Memory 230 may include software components that, when executed by processor 210, perform one or more processes consistent with the disclosed embodiments.

Financial service provider terminal 120 may also be communicatively connected to one or more memory devices (e.g., databases (not shown)) locally or through a network. The remote memory devices may be configured to store information and may be accessed and/or managed by financial service provider terminal 120. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

Financial service provider terminal 120 may also include one or more I/O devices 220 that may comprise one or more interfaces for receiving signals or input from devices and providing signals or output to one or more devices that allow data to be received and/or transmitted by financial service provider terminal 120. For example, financial service provider terminal 120 may include interface components, which may provide interfaces to one or more input devices, such as one or more keyboards, mouse devices, and the like, that enable financial service provider terminal 120 to receive data from one or more users (such as customer terminal 110).

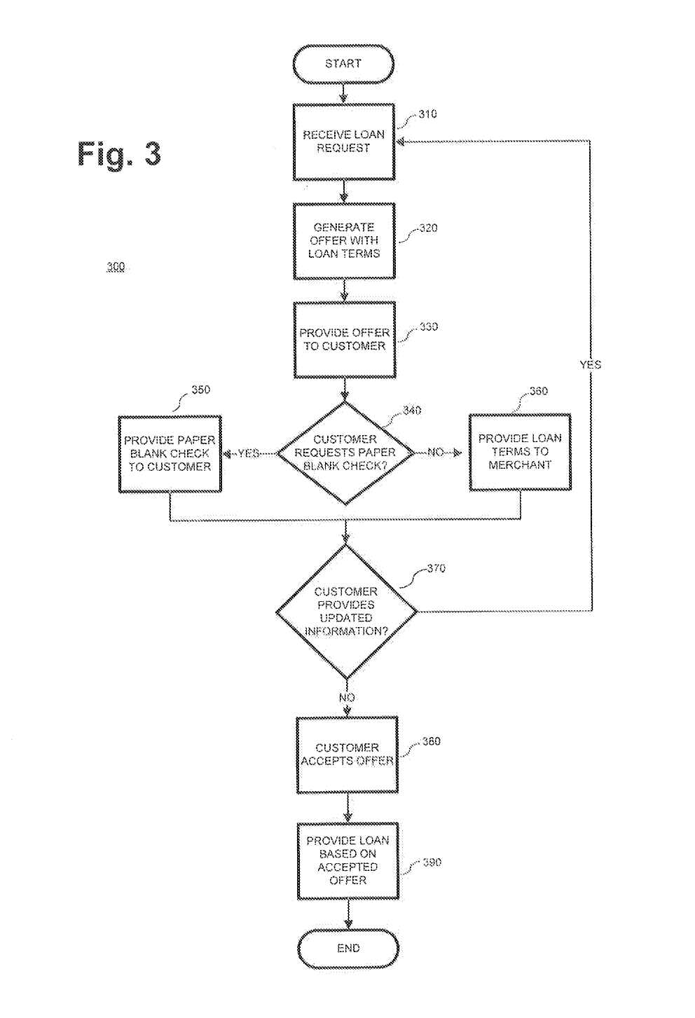

FIG. 3 shows a flowchart of method 300 for providing loan terms to a customer. Method 300 may be performed by financial service provider terminal 120 using processor 210 to execute memory 230. Following method 300, the financial service provider may provide the customer with a digital blank check.

In block 310, financial service provider terminal 120 may receive a loan request from a customer. A customer may submit the loan request using customer terminal 110, which may be a mobile device, at any location, including at the point-of-sale. Alternatively, a customer may submit the loan request via third party communication or in person with a financial service provider.

The loan request may include information relating to loan criteria and customer loan optimization preferences, which may affect the loan terms. Information relating to loan criteria may help a financial service provider evaluate the risk of the loan and may include details about the customer or the item to be purchased. For example, information relating to loan criteria may include the automobile make, model, and year, the vehicle identification (“VIN”) number, proof of income, proof of insurance, and back-end product information. Back-end product information includes features or additional items that may be purchased in connection with the item to be purchased. For example, back-end product information may include tire protection, paint rust proofing coat, extra warranty on the automobile, and gap insurance, which is insurance that covers gaps between coverage. A customer may also have loan optimization preferences, such as optimizing the interest rate, total monthly payment, or number of payments or varying the down payment. The customer's loan preferences may be used to tailor the loan terms to the customer's preferences, making the offer more attractive to the customer.

In block 320, financial service provider terminal 120 may generate an offer with loan terms based on the loan request from block 310. A financial service provider may use databases and/or software to evaluate the risk of a loan and calculate loan terms. By comparing the information provided in a loan request with data, including information provided by other customers and the profitability of loans provided by those customers, a financial service provider may determine appropriate loan terms to maintain profitability. Thus, loan terms may be calculated based on various information included in the loan request data or elsewhere (e.g., information regarding the car, the buyer, the seller, the general economy, the financial service provider's desired profit level for the loan or loans in general, etc.). In some embodiments, a series of loan terms (i.e., multiple permutations of loan duration, rate, loan-to-value, etc.) may be calculated under which a loan offer may be made. Financial service provider terminal 120 or another computer device may be used to generate an offer having loan terms. Alternatively, a financial service provider may generate an offer without use of a device.

Next, as shown in block 330, a financial service provider may provide the offer to the customer. Financial service provider terminal 120 may be used to provide the offer to the customer. Customer terminal 110 may be used to receive the offer from financial service provider terminal 120 via network 140. Alternatively, a financial service provider may provide the offer to the customer without transmitting the offer to customer terminal 110. For instance, the customer may have requested a loan in person and the financial service provider may provide the offer in person as well.

In one embodiment, customer terminal 110, which may be a mobile device, may receive the offer at the point-of-sale location. Further, customer terminal 110 may be configured with one or more software applications to display the loan terms of the offer and information provided with the loan request. Customer terminal 110 may also be configured to provide the offer to the customer under restrictions of the loan. For instance, the customer may only have access to the offer for a specified duration if the offer is valid for a limited time-frame. The customer may accept the offer and use it to purchase an item. Alternatively, customer terminal 110 may be configured to allow the financial service provider to rescind the offer prior to acceptance.

In block 340, the customer may request a paper blank check, which may be specified in the loan request received in block 310. If the customer requests a paper blank check, the financial service provider may provide it to the customer as shown in block 350. Alternatively, if the customer does not request a paper blank check, the financial service provider may provide loan terms of the offer to a merchant potentially selling an item.

A paper blank check enables a customer to write in the amount required, usually within a predetermined range, to purchase an item. The paper blank check may be attached to loan terms for one or more scenarios. For instance, a paper blank check may have a 10 percent interest rate if used to purchase an item over $5,000 or a 12 percent interest rate if used to purchase an item $4,999.99 or less. The loan terms attached to the paper blank check may be representative of loan terms available through other sources, including loan terms that are available on the financial service provider's website or a third party's website, or via communication from the financial service provider to customer terminal 110 or merchant terminal 130. For instance, a paper blank check may have an attachment specifying the loan terms are as specified on www.financialserviceproviderX.com/loanY, allowing the financial service provider to provide one or more subsequent offers as the customer provides updated information. By providing loan terms in an updatable form, such as, for example, through a website, the financial service provider may provide the customer with a digital blank check even though the check itself is paper.

If the customer does not request a paper blank check, the financial service provider provides loan terms to the merchant as shown in block 360. The financial service provider may communicate the loan terms using financial service provider terminal 120. The merchant may receive the loan terms using merchant terminal 130 via network 140. Financial service provider terminal 120 and merchant terminal 130 may be configured to communicate loan terms using secure channels, which may include using third party software such as DealerTrack and/or RouteOne. By providing loan terms directly to the merchant, which enables the financial service provider to also provide authorized updates of the loan terms, financial service provider may provide the customer with a digital blank check.

In block 370, the customer may provide updated information, which may include any information not submitted when the loan request was received (as shown in block 310). For example, a customer may identify an exact automobile to purchase and can provide the VIN to the financial service provider. In another example, a customer may have received a third party offer after negotiating with the merchant and can provide the third party offer to the financial service provider. If the customer provides updated information, method 300 returns to block 310. The financial service provider may provide a subsequent offer with new loan terms based on the subsequent loan request. The customer may provide updated information using customer terminal 110, which may be a mobile device, at the point-of-sale location. Customer terminal 110 may communicate updated information via network 140 to financial service provider terminal 120.

In block 380, the customer may accept the offer. The customer may communicate the acceptance to the financial service provider using customer terminal 110. The financial service provider may receive the acceptance using financial service provider terminal 120 via network 140. The customer's acceptance of the offer may also be communicated to the merchant by the financial service provider or by the customer. Alternatively, in another embodiment, the customer may communicate a counter-offer to the financial service provider. Financial service provider terminal 120 may be configured to provide the counter-offer to the financial service provider under restrictions of the acceptance. For instance, the financial service provider may only have access to the counter-offer for a specified duration if the counter-offer is valid for a limited time-frame. The financial service provider terminal 120 may be configured to allow the customer to rescind the counter-offer prior to acceptance.

Next, in block 390, the financial service provider provides the loan based on the accepted offer to the customer. The financial service provider may provide the loan to the customer in several ways. In one example, if a paper blank check was provided, the customer may fill out and sign the paper blank check. The customer may disclose the loan terms attached to the paper blank check, including loan terms that are available as disclosed in the embodiments, to the merchant. In another example, if the financial service provider provided loan terms to the merchant, financial service provider may communicate the loan to the merchant. The financial service provider may use financial service provider terminal 120 and the merchant may use merchant terminal 130 to communicate via network 140, which may include using secured channels. In another example, if the financial service provider provided loan terms to the merchant, the customer may communicate the accepted offer directly to the merchant in addition to communicating the acceptance to the financial service provider. The customer may use customer terminal 110 and the merchant may use merchant terminal 130 to communicate via network 140. If the financial service provider accepts a counter-offer (not shown), the financial service provider may provide the loan to the customer in accordance with the disclosed embodiments.

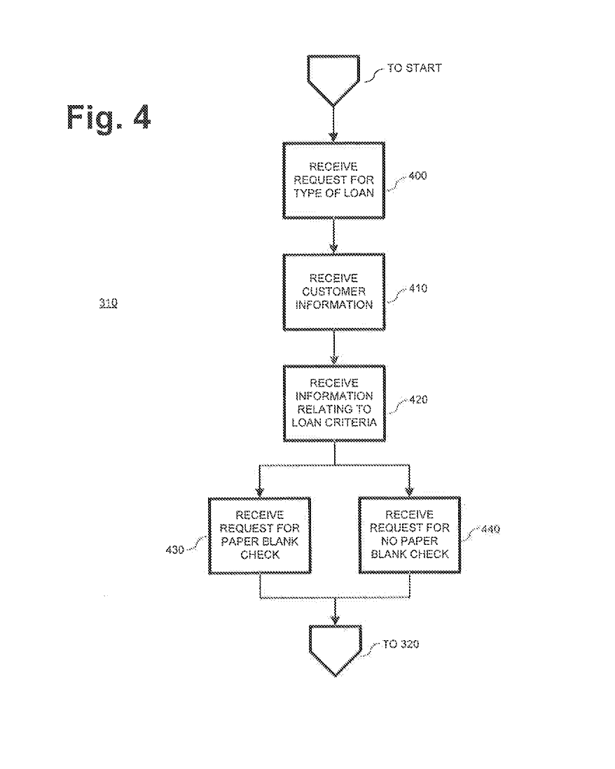

FIG. 4 shows more detail regarding block 310 for receiving a loan request. Through a loan request, a customer may provide the financial service provider with information, including the loan type, customer information, and information relating to loan criteria, which may help the financial service provider to process and categorize the customer's request and to provide a more competitive loan to the customer.

In block 400, the financial service provider may receive a request for a type of loan. For instance, the financial service provider may receive a request for an automobile loan and may categorize the loan request based on loan type. By categorizing the loan request based on loan type, the financial service provider may better evaluate the risk of the loan to generate an offer as shown in block 320. The financial service provider may use financial service provider terminal 120 to receive the request for a type of loan. The customer may use customer terminal 110, which may be a mobile phone, to request the type of loan.

In block 410, the financial service provider may receive customer information. Customer information may be used to identify and contact the customer. The financial service provider may use financial service provider terminal 120 to receive customer information. The customer may use customer terminal 110, which may be a mobile phone, to provide customer information.

In block 420, the financial service provider may receive information relating to loan criteria. For example, information relating to loan criteria may include the automobile make, model, year, and VIN, proof of income, proof of insurance, and back-end product information. The customer may use customer terminal 110 to take pictures of documents showing proof of income or proof of insurance and send the pictures to the financial service provider. The customer may also use customer terminal 110 to take pictures of the item to be purchased, which may be an automobile, to show the condition of the item or back-end product information and send the pictures to the financial service provider. A potential customer may also have loan optimization preferences, such as optimizing the interest rate, total monthly payment, or number of payments or varying the down payment. The customer may provide information relating to loan criteria to the financial service provider using customer terminal 110. Alternatively or additionally, the merchant may provide information relating to loan criteria to the financial service provider, and may use merchant terminal 130. The financial service provider may receive information relating to loan criteria using financial service provider terminal 120, which may be configured to store and categorize the information. Financial service provider terminal 120 may also be configured to use the stored information one or more customers for generating an offer as shown in block 320.

In block 430, the financial service provider may receive a request for a paper blank check from the customer. The financial service provider may use financial service provider terminal 120 and the customer may use customer terminal 110 to communicate the request for a paper blank check via network 140.

In block 440, the financial service provider may receive a request for no paper blank check from the customer. The financial service provider may use financial service provider terminal 120 and the customer may use customer terminal 110 to communicate the request for no paper blank check via network 140.

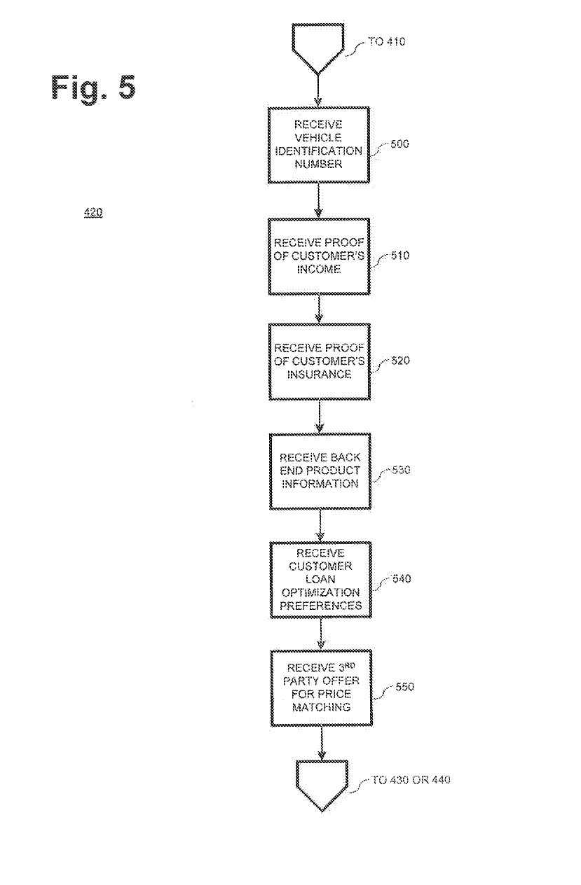

FIG. 5 shows more detail of block 420 for receiving information relating to loan criteria. A customer may provide the financial service provider with information relating to loan criteria, including, VIN, proof of income, proof of insurance, back-end product information, customer loan optimization preferences, and third party offers, which may help the financial service provider to provide a more competitive loan to the customer.

As shown in block 500, the financial service provider may receive a VIN. The financial service provider may use the VIN to better assess the value of an item to be purchased and the risk of a loan, which may enable the most competitive loan offer. The financial service provider may receive the VIN using financial service provider terminal 120. The customer may provide the VIN using customer terminal 110. Alternatively or additionally, the merchant may provide the VIN using merchant terminal 130.

As shown in block 510, the financial service provider may receive proof of the customer's income. The financial service provider may use the customer's income to better assess the value of an item to be purchased and the risk of a loan, which may enable the most competitive loan offer. The financial service provider may receive proof of the customer's income using financial service provider terminal 120. The customer may provide proof of income using customer terminal 110, which may be a mobile phone. For example, the customer may take a picture of a document proving income and use customer terminal 110 to send the picture to the financial service provider. Alternatively or additionally, the merchant may provide the customer's proof of income using merchant terminal 130.

In block 520, the financial service provider may receive proof of the customer's insurance. The financial service provider may use the customer's insurance to better assess the value of an item to be purchased and the risk of a loan, which may enable the most competitive loan offer. The financial service provider may receive proof of the customer's insurance using financial service provider terminal 120. The customer may provide proof of insurance using customer terminal 110, which may be a mobile phone. For example, the customer may take a picture of a document proving insurance and use customer terminal 110 to send the picture to the financial service provider. Alternatively or additionally, the merchant may provide the customer's proof of insurance using merchant terminal 130.

As shown in block 530, the financial service provider may receive back-end product information, which may include tire protection, paint rust proofing coat, extra warranty on the automobile, and/or gap insurance. The financial service provider may use back-end product information to better assess the value of an item to be purchased and the risk of a loan, which may enable the most competitive loan offer. The financial service provider may receive back-end product information using financial service provider terminal 120. The customer may provide back-end product information using customer terminal 110, which may be a mobile phone. For example, the customer may take a picture of a back-end product or document showing back-end product information and use customer terminal 110 to send the picture to the financial service provider. Alternatively or additionally, the merchant may provide back-end product information using merchant terminal 130.

Next, in block 540, the financial service provider may receive the customer's loan optimization preferences, which may include optimizing the interest rate, total monthly payment, or number of payments or varying the down payment. Based on these loan optimization preferences, the financial service provider terminal may tailor a set of loan terms to the customer, making the offer more attractive to the customer. The financial service provider may receive the customer's loan optimization preferences using financial service provider terminal 120. The customer may provide the customer's loan optimization preferences using customer terminal 110, which may be a mobile phone.

In block 550, the financial service provider may receive an offer from a third party for price matching, which may enable the financial service provider to undercut the loan terms of the third party offer to provide the most competitive offer to the customer. For example, a third party may offer a loan to the customer with loan terms that the customer finds more attractive than the loan terms of the offer from the financial service provider. In response, the financial service provider could revise its offer and submit an improved subsequent offer to the customer. The capability of updating loan terms of an offer based on updated information, including a third party offer, may help increase the percentage of consummated loans because it prevents a third party, such as a merchant, from undercutting an offer from the financial service provider and not providing the financial service provider an opportunity to improve the loan terms.

The financial service provider may receive a third party offer using financial service provider terminal 120. The customer may provide the third party offer using customer terminal 110, which may be a mobile phone. For example, the customer may take a picture of a document showing the third party offer and use customer terminal 110 to send the picture to the financial service provider. Alternatively or additionally, the merchant may provide the third party offer, which may come from the merchant, using merchant terminal 130.

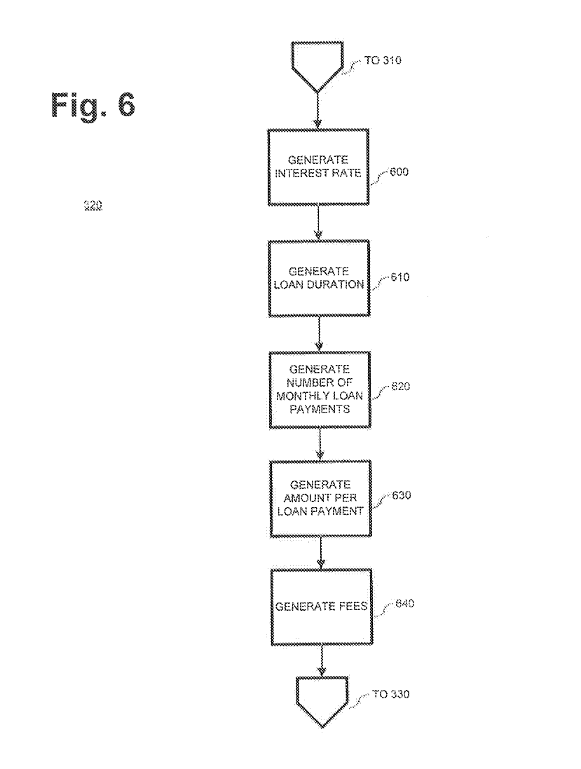

FIG. 6 shows more detail of block 320 for generating an offer with loan terms. Based on the loan request from the customer (shown in block 310), the financial service provider may generate an offer with loan terms, including interest rate, loan duration, number of monthly loan payments, amount per loan payment, and fees.

In block 600, the financial service provider may generate an interest rate. The financial service provider may use financial service provider terminal 120 to generate the interest rate. Financial service provider terminal 120 may be configured to take data collected from other customers and generate an appropriate interest rate that, in combination with other loan terms, may maintain profitability for the financial service provider.

In block 610, the financial service provider may generate loan duration. The financial service provider may use financial service provider terminal 120 to generate loan duration. Financial service provider terminal 120 may be configured to receive data collected from other customers and generate an appropriate loan duration that, in combination with other loan terms, may maintain profitability for the financial service provider.

In block 620, the financial service provider may generate the number of monthly loan payments. The financial service provider may use financial service provider terminal 120 to generate the number of monthly loan payments. Financial service provider terminal 120 may be configured to take data collected from other customers and generate an appropriate number of monthly loan payments that, in combination with other loan terms, may maintain profitability for the financial service provider.

In block 630, the financial service provider may generate the amount per loan payment. The financial service provider may use financial service provider terminal 120 to generate the amount per loan payment. Financial service provider terminal 120 may be configured to take data collected from other customers and generate an appropriate amount per loan payment that, in combination with other loan terms, may maintain profitability for the financial service provider.

In block 640, the financial service provider may generate fees. The financial service provider may use financial service provider terminal 120 to generate fees. Financial service provider terminal 120 may be configured to take data collected from other customers and generate appropriate fees that, in combination with other loan terms, may maintain profitability for the financial service provider.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A system for determining loan terms for a customer, comprising:
a storage device storing instructions; and
a processor configured to execute the instructions in the storage device to:
receive, from a customer device, a first loan request relating to an item;
generate a first offer based on the first loan request;
provide the first offer to the customer device;
receive, from the customer device at a point-of-sale location, a second loan request relating to the item;
generate a second offer based on the second loan request; and
provide the second offer to the customer device at the point-of-sale location.

2. The system of claim 1, wherein the customer device is a mobile device.

3. The system of claim 1, wherein the item is an automobile.

4. The system of claim 3, wherein at least one of the first loan request and the second loan request includes information indicating one or more of an automobile make, an automobile model, an automobile year, or a vehicle identification number.

5. The system of claim 1, wherein at least one of the first loan request and the second loan request includes one or more of proof of income, proof of insurance, back-end product information, or a third party offer.

6. The system of claim 5, wherein the first loan request and/or the second loan request includes a picture of a document indicating the one or more of proof of income, proof of insurance, back-end product information, or a third party offer.

7. The system of claim 1, wherein at least one of the first loan request and the second loan request includes customer loan optimization preferences.

8. The system of claim 1, wherein the processor is further configured to execute the instructions to provide the second offer to a merchant.

9. The system of claim 1, wherein the processor is further configured to execute the instructions to receive a counter-offer from the customer device.

10. A method for determining loan terms for a customer, comprising:
receiving, from a customer device, a first loan request relating to an item;
generating, via one or more processors, a first offer based on the first loan request;
providing the first offer to the customer device;
receiving, from the customer device at a point-of-sale location, a second loan request relating to the item;
generating, via the one or more processors, a second offer based on the second loan request; and
providing the second offer to the customer device at the point-of-sale location.

11. The method of claim 10, wherein the customer device is a mobile device.

12. The method of claim 10, wherein the item is an automobile.

13. The method of claim 12, wherein at least one of receiving the first loan request and receiving the second load request includes receiving information indicating one or more of an automobile make, an automobile model, an automobile year, or a vehicle identification number.

14. The method of claim 10, wherein at least one of receiving the first loan request and receiving the second load request includes receiving one or more of proof of income, proof of insurance, back-end product information, or a third party offer.

15. The method of claim 14, wherein receiving the first loan request and/or receiving the second loan request includes receiving a picture of a document indicating the one or more of proof of income, proof of insurance, back-end product information, or a third party offer.

16. The method of claim 10, wherein at least one of receiving the first loan request and receiving the second load request includes receiving customer loan optimization preferences.

17. The method of claim 10, further comprising sending a paper blank check to the customer.

18. The method of claim 10, further comprising providing the second offer to a merchant.

19. The method of claim 10, further comprising receiving a counter-offer from the customer device.

20. A system for determining loan terms for a customer, comprising:
a storage device storing instructions; and
a processor configured to execute the instructions in the storage device to:
receive, from a mobile device at a point-of-sale location, a loan request relating to an automobile that includes one or more of a vehicle identification number, proof of income, proof of insurance, back-end product information, a customer loan optimization preference, or a third party offer;
generate an offer based on the loan request that includes loan terms; and
provide the offer to the mobile device.
